(19) United States
(12) Patent Application Publication
(10) Pub. No.: US 2021/0310743 A1
(43) Pub. Date: Oct. 7, 2021

(54) REACTION TUBE/MIXING TUBE/HEAT EXCHANGE TUBE AND REACTOR/MIXER/HEAT EXCHANGER COMPRISING THE SAME

(71) Applicant: Qingdao Taitannigao Reactor Co. Ltd, Qingdao (CN)

(72) Inventor: Suming Zhang, Qingdao (CN)

(21) Appl. No.: 17/350,046

(22) Filed: Jun. 17, 2021

Related U.S. Application Data
(63) Continuation-in-part of application No. PCT/CN2019/118506, filed on Nov. 14, 2019.

(30) Foreign Application Priority Data
Dec. 17, 2018 (CN) 201811607047.9

(51) Int. Cl. F28D 7/10; F28F 13/12

(52) U.S. Cl. CPC F28D 7/106; F28D 2021/0052; F28F 13/12

(57) ABSTRACT

A reaction/mixing/heat exchange tube, including an outer tube, an inner tube disposed in the outer tube; and a fluid channel formed between the outer tube and the inner tube. The outer tube includes a wall including a plurality of first flat segments, and a plurality of first communication holes formed between every two adjacent first flat segments.

### CROSS-REFERENCE TO RELAYED APPLICATIONS

This application is a continuation-in-part of International Patent Application No. PCT/CN2019/118506 with an international filing date of Nov. 14, 2019, designating the United States, now pending, and further claims foreign priority benefits to Chinese Patent Application No. 201811607047.9 filed Dec. 17, 2018. The contents of all of the aforementioned applications, including any intervening amendments thereto, are incorporated herein by reference. Inquiries from the public to applicants or assignees concerning this document or the related applications should be directed to: Matthias Scholl P C., Attn.: Dr. Matthias Scholl Esq., 245 First Street, 18th Floor, Cambridge, Mass. 02142.

### BACKGROUND

The disclosure relates to the field of petrochemical industry, fine chemical industry, pharmaceutical preparation, food and beverage industry, etc., and more particularly to a reaction tube/mixing tube/heat exchange tube and a reactor/mixer/heat exchanger comprising the same.

The industrial manufacturing fields such as petrochemical, fine chemical, pharmaceutical preparation, food and beverage often involve in physical mixing or chemical reaction of homogeneous or heterogeneous fluids. The physical mixing and chemical reaction are usually accompanied by strong temperature changes (mostly instantaneous heat release), and improper control will cause disastrous consequences such as fire and explosion. In recent years, more and more microchannel reactors have been developed to improve the mixing or chemical reactions between molecules or submolecules of fluids.

FIG. 1 is a schematic diagram of a microchannel reaction unit of a Corning microreactor. In the figure, the channel is etched or carved on the contact plane of two pieces of material, with a depth of about tens of microns. The fluid enters the heart-shaped structure from the entrance, and is separated into two paths after colliding with the semilunar arc structure. The two paths proceed respectively along two sides of the heart-shaped structure and enter the bottom cavity of the heart-shaped structure, and the fluids are mixed therein. The two separated paths of fluid are mixed therein to form one which is squeezed into a next heart-shaped structure. The two adjacent heart-shaped structures can be connected in series or in parallel as needed. At the same time, the heat exchange is rapidly conducted by the interlayer disposed on both sides of the heat exchanger, and the conduction area is much larger than that of a jacket or coil heat exchanger of a kettle reactor. However, due to the limitation of the structure, the reactor can only bear the pressure below 1.8 MPa and the annual flux of 2000 cubic meters.

Metal capillary microreactors are also used in some industries. However, the section of the capillary is circular. The fluid molecules are mixed in the limited space of the capillary tube, and also have a certain reaction/mixing effect, but the mixing is achieved by a kind of horizontal plug flow. When the fluid flows, the heat exchange effect between the fluid flowing near the tube wall and the outside is different from the heat exchange effect between the fluid flowing in the middle of the tube and the outside.

Static tubular reactor is filled with different specifications of regular or irregular packing in tubes with various diameter, to produce strong turbulence when the fluid flows in the tubes, thus strengthening the reaction and mixing of the fluid. However, the turbulence fails to reach the effect of forced binding between molecules in extremely limited space, but can only increase the chance of binding.

### SUMMARY

The disclosure provides a reaction/mixing/heat exchange tube, comprising an outer tube, an inner tube disposed in the outer tube; and a fluid channel formed between the outer tube and the inner tube. The outer tube comprises a wall comprising a plurality of first flat segments, and a plurality of first communication holes formed between every two adjacent first flat segments.

In a class of this embodiment, the inner tube comprises a wall comprising a plurality of second flat segments, and a plurality of second communication holes formed between every two adjacent second flat segments.

In a class of this embodiment, the plurality of first flat segments is disposed correspondingly to the plurality of second flat segments, respectively.

In a class of this embodiment, a first angle of torsion exists between two adjacent first flat segments, and a second angle of torsion exists between two adjacent second flat segments.

In a class of this embodiment, the inner tube is longer than the outer tube, and two ends of the inner tube extends out of two ends of the outer tube, respectively.

In a class of this embodiment, the two adjacent first flat segments are connected to each other in a torsional way; the two adjacent second flat segments are connected to each other in a torsional way; and a joint of the two adjacent first flat segments and a joint of the two adjacent second flat segments are both in the shape of a smooth trumpet.

In a class of this embodiment, each of the plurality of first flat segments and the plurality of second flat segments comprises two flat surfaces symmetrically disposed with respect to each other.

The disclosure also provides a reactor/mixer/heat exchanger, comprising a shell, a tube plate, an end socket, and the aforesaid reaction tube/mixing tube/heat exchange tube; the reaction tube/mixing tube/heat exchange tube is disposed on the tube plate; the fluid channel is a tube side and a fluid for reaction/mixture/heat exchange flows in the tube side; the outer tube is a shell side, and a heat transfer medium flows in the shell side and an inner cavity of the inner tube.

The following advantages are associated with the reaction tube/mixing tube/heat exchange tube of the disclosure: in the tube, the fluid is repeatedly squeezed, diffused, mixed, reversed, and re-squeezed in the fluid channel, thus achieving the strengthening effect of reaction/mixing between fluid molecules. The heat is instantaneously exchanged through the wall of the outer tube and the wall of the inner tube with the heat exchange medium flowing in the shell side and the inner cavity of the inner tube. The process conditions such as temperature and pressure can be controlled accurately with high safety factor. It is especially suitable for the application of chemical reaction/homogeneous mixing process with strong exothermic, high temperature, high pressure, high toxicity and explosion risk. The tube is easy to produce, with low operating cost.

### BRIEF DESCRIPTION OF THE DRAWINGS

FIG. 1 is a schematic diagram of a microchannel reaction unit of a Corning microreactor in the related art;

FIG. 2 is a schematic diagram of a reaction tube/mixing tube/heat exchange tube according to one embodiment of the disclosure;

FIG. 3 is a section view taken from line A-A in FIG. 2;

FIG. 4 is a schematic diagram of a reaction tube/mixing tube/heat exchange tube in FIG. 3 without an inner tube;

FIG. 5 is a schematic diagram of a reaction tube/mixing tube/heat exchange tube in FIG. 3 without an outer tube;

FIG. 6 is a section view taken from line B-B in FIG. 2; and

FIG. 7 is a schematic diagram of one end of a reaction tube/mixing tube/heat exchange tube in Example 3 of the disclosure.

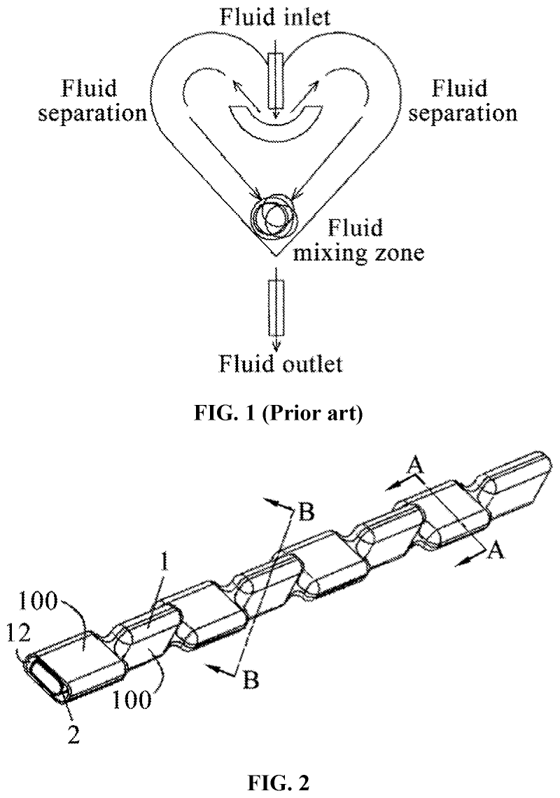

### DETAILED DESCRIPTION

To further illustrate, embodiments detailing a reaction tube/mixing tube/heat exchange tube are described below. It should be noted that the following embodiments are intended to describe and not to limit the disclosure.

### EXAMPLE 1

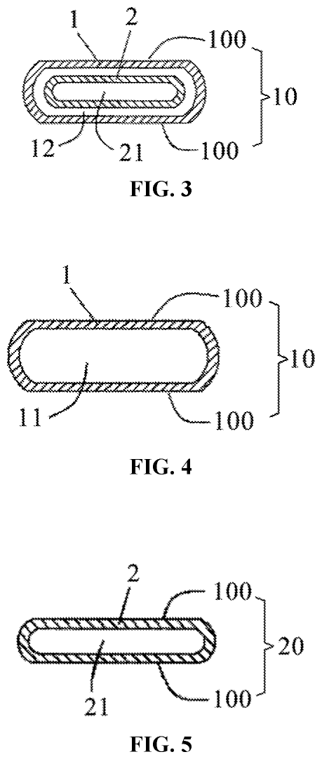

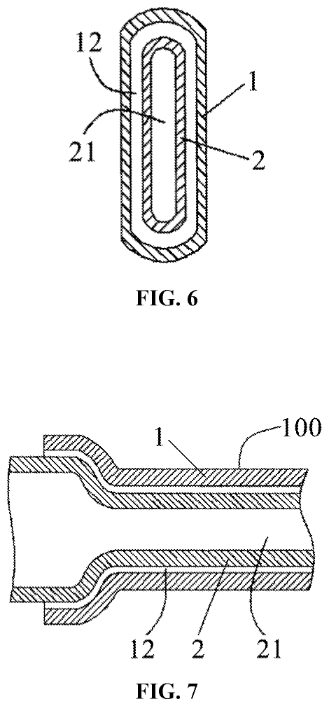

As shown in FIGS. 2-6, the disclosure provides a reaction tube/mixing tube/heat exchange tube comprising an outer tube 1, an inner tube 2 disposed in the outer tube 1, and a fluid channel 12 formed between the outer tube 1 and the inner tube 2. The outer tube 1 comprises a wall comprising a plurality of first flat segments 10, and a plurality of first communication holes 11 formed between every two adjacent first flat segments 10.

The diameter of the outer tube 1 and the inner tube 2 can be selected as needed. When in use for industrial production, the tubes with a large diameter can meet the requirements of industrial production for large output and large tonnage. When in laboratory use, the tubes with a small diameter can meet the requirements of precision experiment.

### EXAMPLE 2

As shown in FIGS. 2-6, based on the disclosure in Example 1, the plurality of first flat segments 10 is disposed correspondingly to the plurality of second flat segments 20, respectively. During processing, the inner tube 2 with circular cross section is inserted into the outer tube 1 which is circular. Parts of the outer tube 1 are flattened by a crushing clamp along the length direction of the outer tube 1. The flattened parts on the outer tube 1 form the plurality of first flat segments 10. In the flattening process, the inner wall of the flattened parts of the outer tube 1 will abut against the outer wall surface of the inner tube 2. When the outer tube is continuously flattened, the inner tube 2 is flattened, too. The flattened parts of the inner tube 2 form the second flat segments 20. Because the plurality of first flat segments 10 and the plurality of second flat segments 20 are formed successively and have the same position, the plurality of first flat segments 10 is corresponding to the plurality of second flat segments 20 in positions, respectively. In this way, the inner tube 2 is limited in the outer tube 1. Optionally, the cross-sectional area of the fluid channel 12 between the outer tube 1 and the inner tube 2 (along the length direction of the outer tube) is not necessarily constant, which can vary irregularly. The processing method is easy to operate, feasible, and cost-effective.

A first angle of torsion exists between two adjacent first flat segments 10, and a second angle of torsion exists between two adjacent second flat segments 20. The first/second angle of torsion is an arbitrary number other than zero. Every two adjacent first/second angles are equal or unequal, or vary irregularly. Because the plurality of first flat segments 10 and the plurality of second flat segments 20 have the same position on the reaction tube/mixing tube/heat exchange tube, the angles of torsion on the inner tube are the same as those on the outer tube. In this way, the first fluid in the fluid channel 12 forms a violent turbulence, so that the heat energy can be quickly transferred, and the optimal temperature required by the process can be accurately controlled.

The inner diameter of the outer tube and the outer diameter of the inner tube are determined as needed, and particularly, there is a space therebetween. The plurality of continuous or discontinuous first/second flat segments with different angles of torsion is distributed on the same position of the axis of the outer tube and the inner tube. Thus, the irregular fluid channel 12 is formed between the outer tube and the inner tube to allow the continuous flowing of materials. In addition, parts of the inner tube are flattened to form the second flat segments, so that a plurality of second communication holes 21 is formed between every two adjacent second flat segments. When in use, the heat transfer medium flowing through the outer wall of the outer tube and the inner wall of the inner pipe simultaneously exchanges heat with the material in the fluid channel 12 between the inner wall of the outer tube and the outer wall of the inner tube, achieving double (crossflow) heat exchange. Because the inner tube is nested in the outer tube, and no fixed support is involved therein, fine high frequency vibration and radial displacement of the fluid occurs when the fluid passes through the irregular fluid channel and the inner cavity of the inner tube quickly, thereby producing intense turbulence.

### EXAMPLE 3

As shown in FIGS. 3-7, the disclosure provides a reaction tube/mixing tube/heat exchange tube comprising an outer tube 1, an inner tube 2 disposed in the outer tube 1, and a fluid channel 12 formed between the outer tube 1 and the inner tube 2. The outer tube 1 comprises a wall comprising a plurality of first flat segments 10, and a plurality of first communication holes 11 formed between every two adjacent first flat segments 10. The inner tube 2 comprises a wall comprising a plurality of second flat segments 20, and a plurality of second communication holes 21 formed between every two adjacent second flat segments 20. The plurality of first flat segments 10 is disposed correspondingly to the plurality of second flat segments 20, respectively. A first angle of torsion exists between two adjacent first flat segments 10, and a second angle of torsion exists between two adjacent second flat segments 20. The two adjacent first flat segments 10 are connected to each other in a torsional way; the two adjacent second flat segments 20 are connected to each other in a torsional way; and a joint of the two adjacent first flat segments 10 and a joint of the two adjacent second flat segments 20 are both in the shape of a smooth trumpet, thus preventing the dead space.

Each of the plurality of first flat segments 10 and the plurality of second flat segments 20 comprises two flat surfaces 100 symmetrically disposed with respect to each other.

As shown in FIG. 7, to facilitate the assembly of the reaction tube/mixing tube/heat exchange tube, the inner tube 2 is longer than the outer tube 1, and two ends of the inner tube 2 extends out of two ends of the outer tube 1, respectively. According to different usages of the reaction tube/mixing tube/heat exchange tube and the requirements of fluid process and production scale, the cross-section area of the fluid channel 11 can be set differently.

A reactor/mixer/heat exchanger, comprising a shell, a tube plate, an end socket, and the aforesaid reaction tube/mixing tube/heat exchange tube. The reaction tube/mixing tube/heat exchange tube is disposed on the tube plate. The fluid channel 12 is a tube side and a fluid for reaction/mixture/heat exchange flows in the tube side. The outer tube 1 is a shell side, and a heat transfer medium flows in the shell side and the inner cavity of the inner tube 2. The fluid molecule to react/mix/exchange heat with others is forcedly squeezed and combined at the first fluid channels 11. When the first fluid passes through the joint of the two adjacent first/second flat segments, it is released, mixed, and twisted, and then enters the next first narrow fluid channel 11 to be squeezed again. The strengthening effect is repeated and better than that of a single plug flow. The heat generated or required during the process is exchanged instantaneously through the wall body of the outer tube 1 and the wall of the inner tube 2 with the heat exchange medium flowing in the shell side and the inner cavity of the inner tube 2. The heat exchange efficiency is much higher than that of common tubular heat exchangers and tubular heat exchangers in the related art, and also higher than that of Corning sandwich heat exchanger (the heat transfer coefficient of glass itself is not high). For example, at present, the Corning reactor can only realize the strong exothermic reaction of certain products with an annual flow rate of 2000 cubic meters, while the reactor of the disclosure can realize the high-pressure, strong exothermic and endothermic reaction of continuous fluid products with an annual output of one million tons.

It will be obvious to those skilled in the art that changes and modifications may be made, and therefore, the aim in the appended claims is to cover all such changes and modifications.

What is claimed is:

1. A device, comprising:
an outer tube;
an inner tube disposed in the outer tube; and
a fluid channel formed between the outer tube and the inner tube; wherein:
the outer tube comprises a wall comprising a plurality of first flat segments, and a plurality of first communication holes formed between every two adjacent first flat segments.

2. The device of claim 1, wherein the inner tube comprises a wall comprising a plurality of second flat segments, and a plurality of second communication holes formed between every two adjacent second flat segments.

3. The device of claim 2, wherein the plurality of first flat segments is disposed correspondingly to the plurality of second flat segments, respectively.

4. The device of claim 3, wherein a first angle of torsion exists between two adjacent first flat segments, and a second angle of torsion exists between two adjacent second flat segments.

5. The device of claim 4, wherein the two adjacent first flat segments are connected to each other in a torsional way; the two adjacent second flat segments are connected to each other in a torsional way; and a joint of the two adjacent first flat segments and a joint of the two adjacent second flat segments are both in the shape of a smooth trumpet.

6. The device of claim 4, wherein each of the plurality of first flat segments and the plurality of second flat segments comprises two flat surfaces symmetrically disposed with respect to each other.

7. The device of claim 4, wherein the inner tube is longer than the outer tube, and two ends of the inner tube extends out of two ends of the outer tube, respectively.

8. A reactor/mixer/heat exchanger, comprising a shell, a tube plate, an end socket, and the device of claim 1; wherein the device is disposed on the tube plate; the fluid channel is a tube side and a fluid for reaction/mixture/heat exchange flows in the tube side; the outer tube is a shell side, and a heat transfer medium flows in the shell side and an inner cavity of the inner tube.
